(19) United States
(12) Patent Application Publication
(10) Pub. No.: US 2021/0325970 A1
(43) Pub. Date: Oct. 21, 2021

(54) INTERACTIVE DISPLAY METHOD, DISPLAY TERMINAL AND INTERACTIVE DISPLAY SYSTEM

(71) Applicant: BOE TECHNOLOGY GROUP CO., LTD.

(72) Inventors: Chih Jen CHENG, Beijing (CN); Xiaoliang DING, Beijing (CN); Yanling HAN, Beijing (CN); Pengpeng WANG, Beijing (CN); Ping ZHANG, Beijing (CN); Wei LIU, Beijing (CN); Xueyou CAO, Beijing (CN)

(73) Assignee: BOE TECHNOLOGY GROUP CO., LTD., Beijing (CN)

(21) Appl. No.: 16/327,667

(22) PCT Filed: Jul. 24, 2018
(86) PCT No.: PCT/CN2018/096856

§ 371 Date: Feb. 22, 2019

(30) Foreign Application Priority Data
Sep. 25, 2017 (CN) 201710880638.2

(51) Int. Cl. G06F 3/01; G06F 3/14; G06F 3/0488; G06F 3/0484

(52) U.S. Cl. CPC G06F 3/017; G06F 3/04842; G06F 3/04883; G06F 3/1454

(57) ABSTRACT

An embodiment of the present disclosure provides an interactive display method. The interactive display method includes: first, establishing a connection between a first terminal and a second terminal; then, obtaining a first gesture of a user; next, the first terminal sending at least a part of first display data to the second terminal according to the first gesture; the second terminal displaying the at least a part of the first display data. A display terminal and an interactive display system are also provided.

### TECHNICAL FIELD

The present disclosure relates to a field of display technology, and more particularly, to an interactive display method, a display terminal and an interactive display system.

### BACKGROUND

With the continuous development of display technology, a plurality of display devices having display function are connected to each other, and a technology for realizing information sharing is becoming more and more popular in daily life.

Taking a mobile phone and a television that are interconnected as an example, in the prior art, when the mobile phone display screen and the television display screen independently run their respective display interfaces, a user needs to perform a touch control operation on the mobile phone to click on a certain application on the mobile phone, so that the image displayed on the television display screen can be projected onto the mobile phone display screen. In this case, when the user performs other operations on the mobile phone, for example, replying to a texting, the application needs to be clicked on by the touch control operation again, so that the display image on the television display screen is projected onto the mobile phone display screen again. In this way, the interactive display process of the mobile phone display screen and the television display screen is cumbersome and the user experience is poor.

### SUMMARY

One aspect of the present disclosure provides an interactive display method, which comprises: establishing a connection between a first terminal and a second terminal; obtaining a first gesture of a user; the first terminal sending at least a part of first display data to the second terminal according to the first gesture; and the second terminal displaying the at least a part of the first display data.

For example, after establishing the connection between the first terminal and the second terminal, and before obtaining the first gesture of the user, the interactive display method further comprises: obtaining a second gesture of the user; the first terminal determining a selected display region in a display image of the first terminal defined by the user according to the second gesture.

For example, the first terminal sending the at least a part of first display data to the second terminal according to the first gesture, comprises: the first terminal sending a part of the first display data that matches the selected display region to the second terminal according to the first gesture.

For example, after the first terminal sending the at least a part of first display data to the second terminal according to the first gesture, the interactive display method further comprises: obtaining a third gesture of the user; the second terminal displaying the at least a part of the first display data according to the third gesture.

For example, after obtaining the third gesture of the user, the interactive display method further comprises: obtaining a time difference between an end of the first gesture and an beginning of the third gesture; comparing the time difference with a preset time, when the time difference is less than or equal to the preset time, the second terminal displaying the at least a part of the first display data.

For example, after the second terminal displaying, the interactive display method further comprises: the second terminal receiving an operation instruction of the user; the second terminal generating a second display data and sending the second display data to the first terminal according to the operation instruction; and at least a portion of the first terminal displaying the second display data.

For example, in a case of the second gesture of the user being obtained and the selected display region being determined according to the second gesture, the at least a portion of the first terminal displaying the second display data, comprises: a portion of the first terminal corresponding to the selected display region displaying the second display data, and a remaining portion displaying the first display data.

For example, establishing the connection between the first terminal and the second terminal, comprises: establishing the connection between the first terminal and the second terminal in a peer to peer manner.

For example, the first terminal sending the at least a part of first display data to the second terminal according to the first gesture, comprises: the first terminal sending the at least a part of the first display data to a storage device; the second terminal obtaining the at least a part of the first display data from the storage device and displaying.

At least an embodiment according to the present disclosure also provides a display terminal, which comprises: a display, a transmitter, a receiver, at least one set of acquisition devices, a communication interface and a processor connected by a bus; wherein the communication interface is configured to establish a connection between the terminal and another terminal; the acquisition devices are configured to obtain a first gesture of a user; the processor is configured to judge the first gesture and generate a control instruction; the transmitter is configured to send a first display data of the terminal to the another terminal according to the control instruction; the receiver is configured to receive a display data sent by the another terminal; and the display is configured to display data.

For example, after establishing the connection with the another terminal, the acquisition devices further obtain a second gesture of the user; the processor determines a selected display region in a display image of the terminal defined by the user according to the second gesture.

Foe example, the transmitter sends a part of the first display data that matches the selected display region to the another terminal according to an instruction generated by the processor based on the first gesture and the second gesture.

For example, the acquisition devices obtain a third gesture of the user; the receiver receives at least a part of the display data sent by the another terminal according to an instruction generated by the processor based on the third gesture.

For example, after the acquisition devices obtain the third gesture of the user, the acquisition devices further obtain a time difference between an end of the first gesture and an beginning of the third gesture; the processor compares the time difference with a preset time, and when the time difference is less than or equal to the preset time, instructs the receiver to receive the at least a part of the display data sent by the another terminal.

For example, after a display of the another terminal displays, the another terminal further receives an operation instruction of the user; the another terminal generates a second display data and sends the second display data to the terminal according to the operation instruction; and at least a portion of the terminal displays the second display data.

For example, in a case that the acquisition devices of the terminal obtain the second gesture of the user and the processor determines the selected display region according to the second gesture, a portion of the display corresponding to the selected display region displays the second display data, and a remaining portion displays the first display data.

At least an embodiment according to the present disclosure also provides an interactive display system, which comprises any one of the display terminals described above.

For example, the display system further comprises a storage device, wherein the storage device is configured to store the first display data sent by the display terminal.

### BRIEF DESCRIPTION OF THE DRAWINGS

In order to clearly illustrate the technical solutions of the embodiments of the disclosure or the technical solutions in the prior art, the accompanying drawings to be used to describe the embodiments or the prior art will be briefly described in the following; it is obvious that the described drawings are only related to some embodiments of the disclosure, and for those skilled in the art, other drawing(s) can be obtained based on the accompanying drawings without any inventive work.

FIG. 1 is a flowchart of an interactive display method provided by an embodiment of the present disclosure;

FIG. 2a is a connection manner of two terminals in an interactive display provided by an embodiment of the present disclosure;

FIG. 2b is a connection manner of two terminals in an interactive display provided by another embodiment of the present disclosure;

FIG. 3 is a first schematic diagram of a scene corresponding to the first terminal obtaining a gesture in step 1 in FIG. 1;

FIG. 4 is schematic diagram of a user performing an interactive display provided by an embodiment of the present disclosure;

FIG. 5 is a first schematic diagram of an interactive display scenario provided by an embodiment of the present disclosure;

FIG. 6 is a second schematic diagram of a scene corresponding to the first terminal obtaining a gesture in step 1 in FIG. 1;

FIG. 7 is a second schematic diagram of an interactive display scenario provided by an embodiment of the present disclosure;

FIG. 8 is a third schematic diagram of an interactive display scenario provided by an embodiment of the present disclosure;

FIG. 9 is a fourth schematic diagram of an interactive display scenario provided by an embodiment of the present disclosure;

FIG. 10 is a fifth schematic diagram of an interactive display scenario provided by an embodiment of the present disclosure;

FIG. 11 is a schematic diagram of a user operating a second terminal shown in FIG. 2a;

FIG. 12 is a sixth schematic diagram of an interactive display scenario provided by an embodiment of the present disclosure;

FIG. 13 is a flowchart of an interactive display method provided by another embodiment of the present disclosure;

FIG. 14 is a schematic structural diagram of a terminal provided by an embodiment of the present disclosure;

FIG. 15 is a schematic diagram of a setting manner of acquisition devices on a first terminal shown in FIG. 2a;

FIG. 16 is a schematic diagram of a setting manner of acquisition devices on a second terminal shown in FIG. 2a;

FIG. 17 is a schematic diagram of a user located in a far side interaction space provided by an embodiment of the present disclosure;

FIG. 18 is a schematic diagram of a user located in a far side interaction space and a near side interaction space provided by an embodiment of the present disclosure.

Description of the numerals: 100—selected display region; 10—first terminal; 20—second terminal; 301—display; 302—transmitter; 303—receiver; 304—acquisition devices; 314—time of flight camera; 324—time of flight emitter; 334—left camera; 344—right camera; 354—structured light camera; 364—structured light emitter; 374—radar microwave sensor; 305—communication interface; 306—processor; 307—storage; 308—touch control device; S1—far side interaction space; S2—near side interaction space.

### DETAILED DESCRIPTION

Hereinafter, the technical solutions of the embodiments will be described in a clearly and fully understandable way in connection with the drawings related to the embodiments of the present disclosure. Apparently, the described embodiments are just a part but not all of the embodiments of the disclosure. Based on the described embodiments of the present disclosure, those skilled in the art can obtain other embodiment(s), without any inventive work, which should be within the protection scope of the disclosure.

In the following, the terms “first,” “second,” etc., are used only for descriptive purposes, and are not intended to indicate or imply a relative importance, or implicitly indicating the number of technical features indicated. Therefore, features defined by “first,” “second,” can include one or more of the features either explicitly or implicitly. In the description of the embodiment(s) of the present disclosure, “a plurality of” means two or more unless otherwise specified.

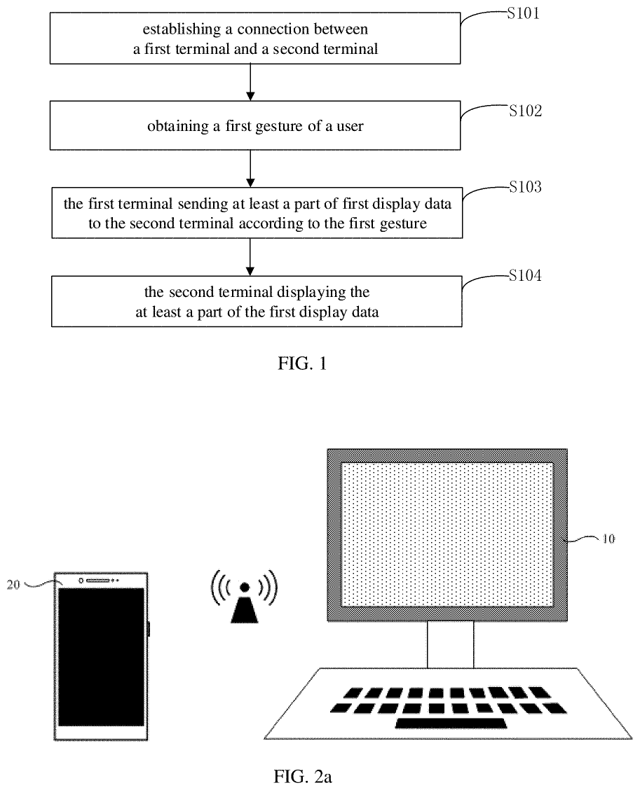

An embodiment of the present disclosure provides an interactive display method, as shown in FIG. 1, which comprises:

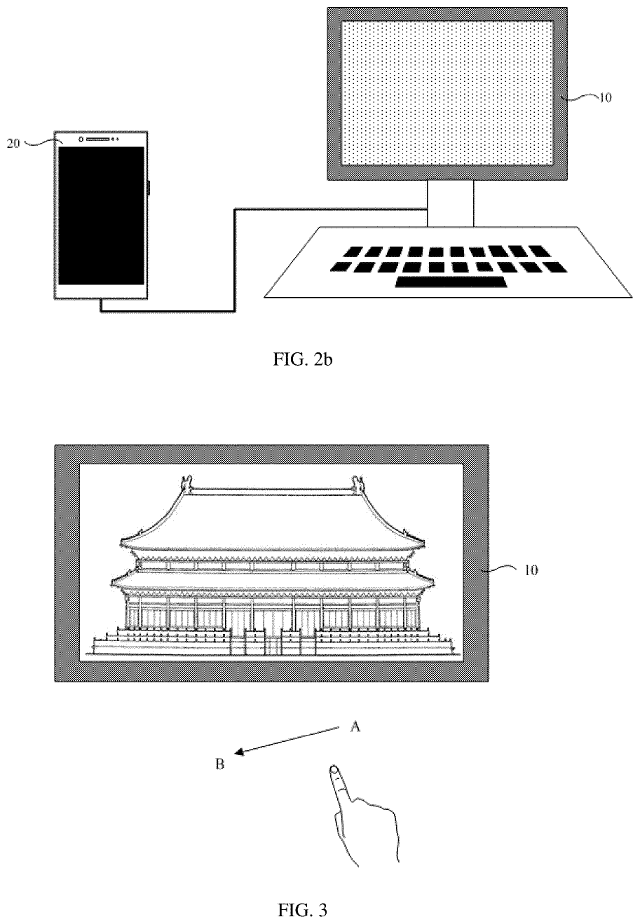

S101: establishing a connection between a first terminal 10 and a second terminal 20, as shown in FIG. 2a or FIG. 2b.

According to an example of the present disclosure, the connection between the first terminal 10 and the second terminal 20 mentioned above can be established in a peer to peer (P2P) manner.

Exemplarily, the first terminal 10 can be a desktop computer or a separate display of a large size, and the second terminal 20 can be a display of a small size, such as a mobile phone. Alternatively, the first terminal 10 can be a mobile phone, and the second terminal 20 can be a desktop computer or a separate display. The embodiment of the present disclosure does not limit this. Hereinafter, for convenience of illustration, the following description is based on that the first terminal 10 is a computer and the second terminal 20 is a mobile phone.

In this case, as shown in FIG. 2a, the first terminal 10 can establish the above-mentioned peer to peer connection with the second terminal 20 by means of wireless communication (for example, Wi-Fi, Bluetooth), so as to enable communication between the first terminal 10 and the second terminal 20. Alternatively, as shown in FIG. 2b, the first terminal 10 can also establish the above-mentioned peer to peer connection with the second terminal 20 by means of wired communication (for example, a signal line), which is not limited by the embodiment of the present disclosure.

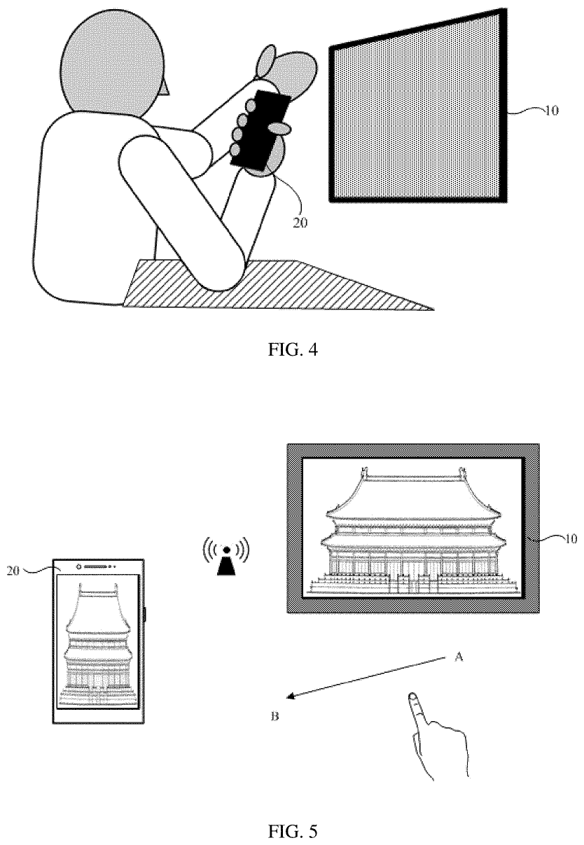

S102: as shown in FIG. 3, obtaining a first gesture of a user.

Alternatively, the step of obtaining the first gesture of the user in step S102 can be that the first terminal 10 obtains the first gesture, or the second terminal 20 obtains the first gesture. Alternatively, the aforementioned step S102 can also be that the first terminal 10 and the second terminal 20 obtain the first gesture of the user simultaneously. In addition, the aforementioned step S102 can also be that other terminal other than the first terminal 10 and the second terminal 20 obtains the first gesture. The embodiment of the present disclosure does not limit this. In addition, the obtainments of a second gesture and a third gesture in the following are similar to the obtainment of the first gesture, and the second gesture and the third gesture can also be obtained by the first terminal, or the second terminal, or any terminal other than the first terminal and the second terminal, which is not limited by the embodiment of the present disclosure. The content of the embodiment of the present disclosure is described by taking that the first gesture, the second gesture, and/or the third gesture are obtained by the first terminal 10 or the second terminal 20 as an example. Those skilled in the art can learn the manner in which other terminal is used to obtain a gesture according to the following examples.

Exemplarily, the first gesture in FIG. 3 is an action of the user's finger sliding from point A to point B along a straight line. The distance between point A and the first terminal 10 is less than the distance between point B and the first terminal 10. In this case, the first gesture described above is a dragging action. Of course, the first gesture described above can also be a sliding from point A to point B along a curved line. The embodiment of the present disclosure does not limit this.

Based on this, when the user performs the first gesture described above, as shown in FIG. 4, the second terminal 20 (i.e., the mobile phone) can be placed in the right hand of the user, and then the first gesture is performed by a finger of the left hand. Alternatively, the left hand holds the mobile phone, and the right hand performs the first gesture described above. Alternatively, the mobile phone can be placed on a desk and the first gesture described above can be performed by the left or right hand. The embodiment of the present disclosure does not limit this.

S103: the first terminal 10 sending at least a part of first display data to the second terminal 20 according to the first gesture.

The first display data is the data displayed by the first terminal 10. According to an example of the present disclosure, it can be a frame of image being displayed by the first terminal 10. Alternatively, it can be one previous frame or several previous frames of images that have already been displayed. Alternatively, it can be one frame or several frames of images to be displayed. The embodiment of the present disclosure does not limit this. Hereinafter, for convenience of illustration, the following description is made by taking that the first display data is a frame of image being displayed by the first terminal 10 as an example.

S104: the second terminal 20, as shown in FIG. 5, displaying the at least a part of the first display data.

Exemplarily, in the aforementioned step S103, the first terminal 10 sends all of the first display data to the second terminal 20, and in this case, after receiving the first display data, the second terminal 20 displays the same image as the image displayed by the first terminal 10.

According to an example of the present disclosure, the sending step in step S103 and the receiving step in the example of step S104 can be performed simultaneously, that is, direct sending. For example, the first terminal sends, and the second terminal receives simultaneously. According to another example of the present disclosure, the aforementioned sending and receiving steps can also be performed separately. For example, there is a storage device between the first terminal and the second terminal, the first terminal sends to the storage device to store, and the second terminal obtains data from the storage device and displays. The storage device can be a local storage device, and of course, can also be a cloud storage device.

In summary, in the interactive display method provided by the embodiment of the present disclosure, after the connection between the first terminal 10 and the second terminal 20 is established, the first terminal 10 can send at least a part of the first display data displayed by the first terminal to the second terminal 20 by the first terminal 10 and/or the second terminal 20 judging the first gesture of the user (for example, the above-described dragging action), so that the second terminal 20 can display based on the received display data. In this way, when the user performs other operations on the second terminal 20 (for example, the mobile phone), for example, replying to a texting, and needs to display at least a part of the display image of the first terminal 10 on the second terminal 20, the touch control operation on the second terminal 20 is not necessary, and the sharing display between the display images of the first terminal 10 and the second terminal 20 can be realized only by performing the first gesture, thus simplifying the process of the interactive.

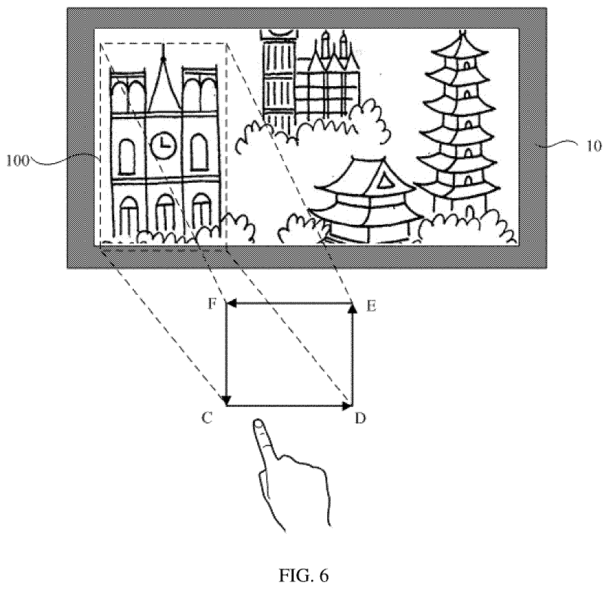

As can be seen form the above description, in step S103, the first terminal 10 can send at least a part of the first display data to the second terminal 20 according to the first gesture. In this case, the first terminal 10 can send a part of the first display data to the second terminal 20 to enable the user to have a detailed understanding of the partial information or image details in the display image of the first terminal 10. Based on this, in order to make the image corresponding to the part of the first display data sent by the first terminal 10 consistent with the image that the user needs to see on the second terminal 20 in the desired state, after the connection between the first terminal 10 and the second terminal 20 is established, before the first gesture of the user is obtained by the first terminal 10 and/or the second terminal 20, the interactive display method further comprises: as shown in FIG. 6, the first terminal 10 obtaining a second gesture of the user.

Exemplarily, the second gesture in FIG. 6 is the user's finger sliding from point C in turn to point D, point E, point F and point C along straight lines.

Next, according to the second gesture described above, the first terminal 10 determines a selected display region 100 in the display image of the first terminal 10 defined by the user.

Next, after the first terminal 10 and/or the second terminal 20 obtain the first gesture of the user (the dragging action from point A to point B as shown in FIG. 5), step S103 comprises: the first terminal 10 sending a part of the first display data that matches the selected display region 100 to the second terminal 20 according to the second gesture.

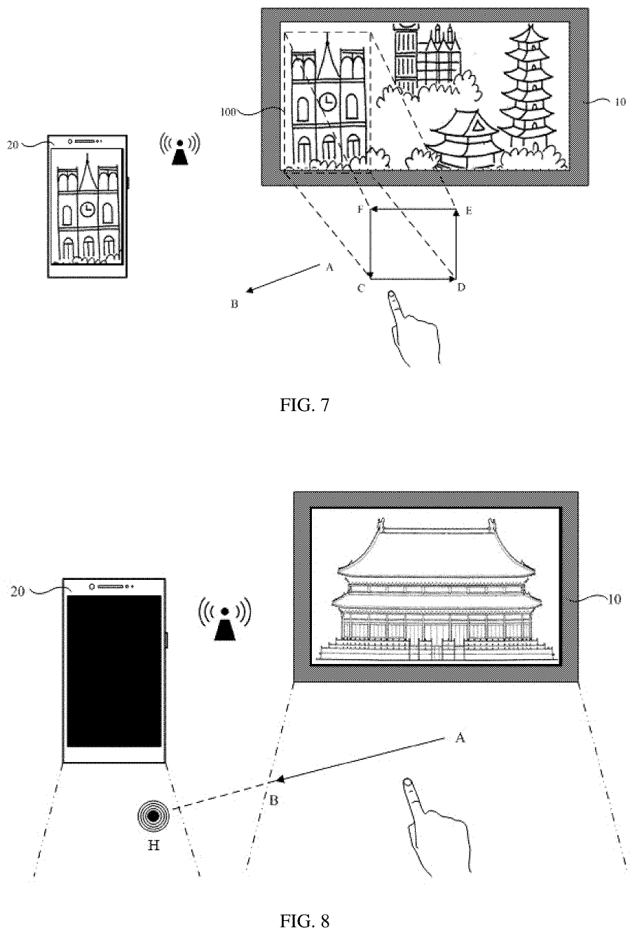

In this case, step S104 described above is executed, so that the second terminal 20 displays the image corresponding to the selected display region 100, as shown in FIG. 7, thus enabling the user to observe a part, in partial magnification, of the complete image corresponding to the first display data, by observing the image displayed on the second terminal 20. At the same time, the first terminal 10 still displays the complete image corresponding to the first display data described above, so that the viewing angle of the display image of the first terminal 10 will not be lost.

According to an example of the present disclosure, the step of the first terminal 10 sending a part of the first display data that matches the selected display region 100 to the second terminal according to the second gesture, and the receiving step of the second terminal 20 in the example of step S104, can be performed simultaneously, that is, direct sending. For example, the first terminal 10 sends, and the second terminal 20 receives simultaneously. According to another example of the present disclosure, the aforementioned sending and receiving steps can also be performed separately. For example, there is a storage device between the first terminal and the second terminal, the first terminal sends to the storage device to store, and the second terminal obtains data from the storage device and displays. The storage device can be a local storage device, and of course, can also be a cloud storage device.

On this basis, in the interactive display process mentioned above, an incorrect operation of the first terminal 10 or the second terminal 20 caused by an incorrect trigger gesture should be avoided. For example, taking that the second terminal 20 is a computer display capable of displaying a dashboard on an aircraft as an example, if the user falsely executes the first gesture described above, the second terminal 20 will receive at least a part of the first display data output by the first terminal 10 and display it. In this way, the originally displayed data of the dashboard on the second terminal 20 cannot be displayed normally, which is not conducive to flight safety.

In order to solve the aforementioned problem, after step S103, before the second terminal 20 displaying the image, the interactive display method further comprises: as shown in FIG. 8, the second terminal 20 obtaining a third gesture of the user (a clicking action at point H).

Exemplarily, the third gesture described above is clicking at point H, so that the first gesture and the third gesture together constitute an action from dragging (point A) to pulling (point B) and to releasing (point H).

Next, the second terminal 20 receives the at least a part of the first display data to display according to the third gesture. According to an example of the present disclosure, the step of the first terminal 10 sending the first display data, and the step of the second terminal 20 receiving the first display data, can be performed simultaneously, that is, direct sending. For example, the first terminal 10 sends, and the second terminal 20 receives simultaneously. According to another example of the present disclosure, the aforementioned sending and receiving steps can also be performed separately. For example, there is a storage device between the first terminal and the second terminal, the first terminal sends to the storage device to store, and the second terminal obtains data from the storage device and displays. The storage device can be a local storage device, and of course, can also be a cloud storage device.

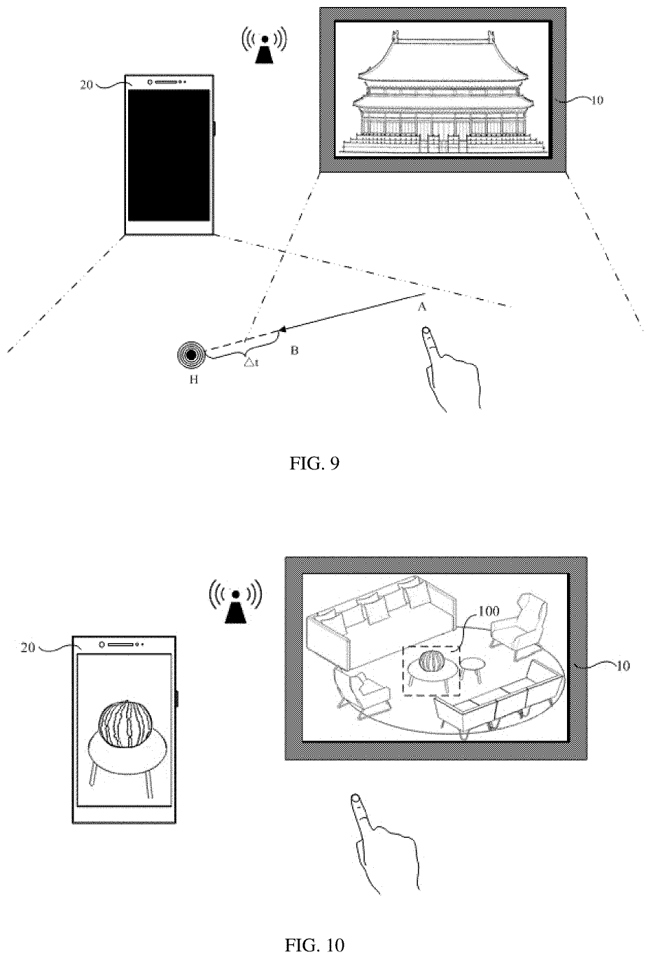

Alternatively, in order to solve the aforementioned problem, after step S103, before the second terminal 20 displaying the image, the interactive display method further comprises: as shown in FIG. 9, the second terminal 20 obtaining the first gesture of the user (a dragging action from point A to point B) and the third gesture of the user (a clicking action at point H).

Then, the second terminal 20 receives the at least a part of the first display data to display according to the first gesture and the third gesture.

The difference between FIG. 8 and FIG. 9 is that in FIG. 8, the first gesture (the dragging action from point A to point B) is only within the detection range of the first terminal 10, and the third gesture (the clicking action at point H) is within the detection range of the second terminal 20, while in FIG. 9, both the first gesture (the dragging action from point A to point B) and the third gesture (the clicking action at point H) are within the detection range of the second terminal 20. The embodiment of the present disclosure does not limit this.

In this way, in the case that the second terminal 20 does not receive the third gesture described above (the clicking action at point H), even if the first terminal 10 sends the at least a part of the first display data to the second terminal 20 according to the first gesture (the dragging action from point A to point B), the second terminal 20 will not display the at least a part of the first display data, thus not affecting the picture being displayed by the second terminal 20. It can be seen from the above description that by adding the judgment of the third gesture, the recognition accuracy of the gesture of the user can be improved, and the incorrect trigger operation can be avoided.

In order to further improve the judgment accuracy of the gesture, after the second terminal 20 obtains the third gesture of the user (the clicking action at point H), before the second terminal 20 displays the image, the interactive display method further comprises: as shown in FIG. 9, the second terminal 20 obtaining a time difference At between an end of the first gesture (point B) and an beginning of the third gesture (point H).

Next, the second terminal 20 compares the time difference At with a preset time T, when the time difference Δt is less than or equal to the preset time T, the second terminal 20 displays the at least a part of the first display data.

Exemplarily, the preset time T may be set between 0.5 s and 1 s. In this way, when the time difference Δt between the end of the first gesture (point B) and the beginning of the third gesture (point H) is greater than the preset time, it can be proved that the first gesture and the third gesture are not continuous. Therefore, it can be determined that the gesture performed by the user is not a continuous action from dragging to releasing combined of the first gesture and the third gesture. At this time, the second terminal 20 does not need to display the first display data sent by the first terminal 10, so that an incorrect display operation caused by the incorrect trigger of the user can be avoided.

Based on this, the user can also perform corresponding operations on the second terminal 20 to change the display image of the first terminal 10.

According to an example of the present disclosure, after the second terminal displaying, the interactive display method further comprises the following steps.

First, as shown in FIG. 10, the second terminal 20 receiving an operation instruction of the user.

When the second terminal 20 is provided with a touch control function, the operation instruction can be a touch control operation having a contact characteristic; alternatively, the operation instruction can be some non-contact gestures; alternatively, the operation instruction can be an instruction combined of a touch control operation and a gesture. The embodiment of the present disclosure does not limit this.

Exemplarily, as shown in FIG. 10, the first terminal 10 displays an image, and the user performs the second gesture to determine a selected display region 100 in the image displayed by the first terminal 10, a fruit (a watermelon) being displayed in the selected display area 100. Next, the user performs the first gesture and the third gesture to complete the dragging to releasing action, so that the second terminal 20 displays the fruit in the selected display region 100.

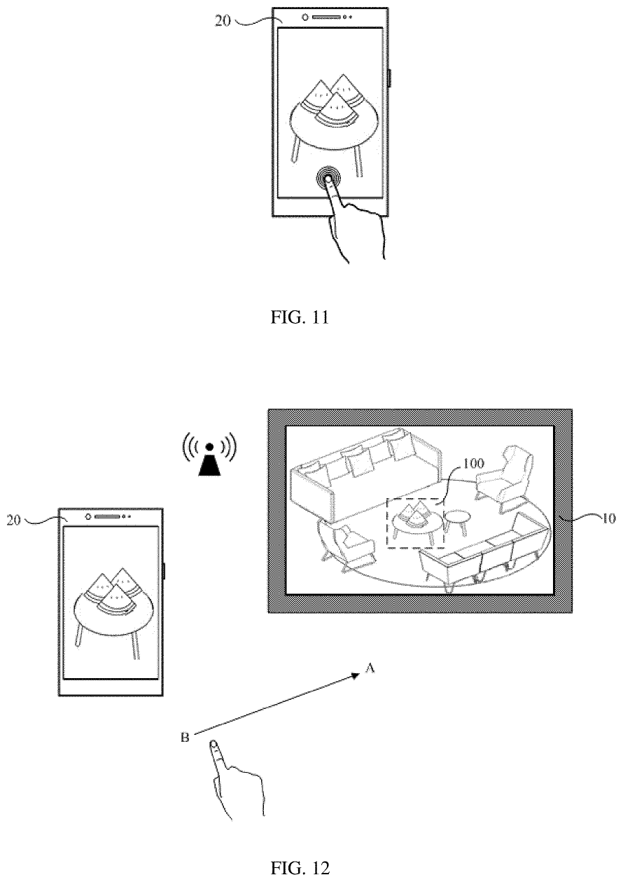

At this time, taking that the operation instruction of the user is combined of the touch control operation and the gesture as an example, the user first cuts the fruit displayed on the second terminal 20 by performing a touch control operation on the second terminal 20, as shown in FIG. 11. Then, as shown in FIG. 12, the user performs a gesture opposite to the first gesture in the direction, that is, an outward pulling action of sliding from point B to point A along a straight line.

Next, according to the operation instruction described above, the second terminal 20 generates a second display data, and sends the second display data to the first terminal 10.

Then, at least a portion of the first terminal 10 displays the second display data.

Based on this, it can be seen from the above description that, as shown in FIG. 10, the first terminal 10 obtains the second gesture of the user, and determines the selected display region 100 according to the second gesture. In this case, after the second terminal 20 receives the operation instruction of the user and generates the second display data according to the operation instruction, the at least a portion of the first terminal 10 displaying the second display data, comprises: as shown in FIG. 12, a portion of the first terminal 10 corresponding to the selected display region 100 displaying the second display data, and a remaining portion displaying the first display data, that is, the portion of the first terminal 10 corresponding to the selected display region 100 displaying the cut watermelon, and the remaining portion still maintaining and displaying the original display data.

Of course, the selected display region 100 of the first terminal 10 is described by taking an uncut fruit as an example. When the selected display area 100 displays an unopened book, the user can also display the book on the second terminal 20 and flip the book by performing the operation described above, and then display the image of the opened book on the portion corresponding to the selected display region 100 of the first terminal 10 in the same manner. In this case, when the second terminals 20 of a plurality of users establish a connection with the first terminal 10, the users can respectively display the display content displayed on a respective second terminal 20, such as an unfolded project file, etc., on the same first terminal 10, thus facilitating discussion during a meeting, and solving the problem of loss of viewing angle and time consumption caused by partial display by regions of a divided screen.

It should be noted that, the above description takes that the first terminal 10 is a display screen of a large size and the second terminal 20 is a display screen of a small size as an example, and the interactive display method of the first terminal 10 and the second terminal 20 is illustrated. Of course, when the first terminal 10 is a display screen of a small size and the second terminal 20 is a display screen of a large size, the aforementioned method is also applicable, and details are not repeatedly described herein.

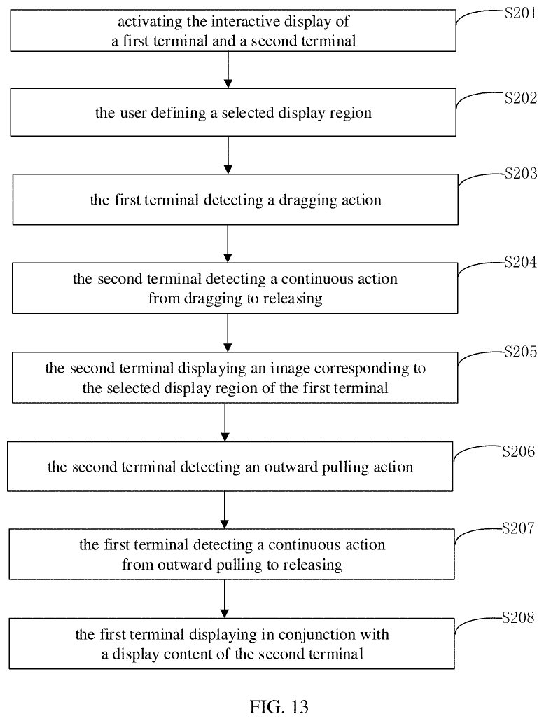

In summary, the interactive display process of the first terminal 10 and the second terminal 20, as shown in FIG. 13, mainly comprises the following steps.

S201: activating the interactive display of a first terminal 10 and a second terminal 20.

According to an example of the present disclosure, a connection is established between the first terminal 10 and the second terminal 20 through step S101 described above.

S202: the user defining a selected display region 100.

According to an example of the present disclosure, as shown in FIG. 6, the user defines the selected display region 100 in the display image of the first terminal 10 by performing the second gesture (sliding from point C in turn to point D, point E and point F along straight lines).

S203: the first terminal 10 detecting a dragging action.

Alternatively, step 203 can be that the second terminal 20 detects the dragging action; alternatively, step 203 can also be that the first terminal and the second terminal 20 detect the dragging action.

According to an example of the present disclosure, as shown in FIG. 3, the dragging action can be the first gesture of a finger sliding from point A to point B along a straight line.

S204: the second terminal 20 detecting a continuous action from dragging to releasing.

According to an example of the present disclosure, the releasing action, as shown in FIG. 3, is a clicking action at point H, namely the third gesture. Based on this, the second terminal further needs to judge the continuity between the first gesture and the second gesture, so as to eliminate the possibility of an incorrect operation of the user.

S205: the second terminal 20 displaying an image corresponding to the selected display region 100 of the first terminal 10.

According to an example of the present disclosure, the first terminal 10 sends the display data corresponding to the selected display region 100 to the second terminal 20, and the second terminal 20 receives and displays the display data when the second terminal 20 determines that the continuity of the first gesture and the second gesture conforms to a regulation.

S206: the second terminal 20 detecting an outward pulling action.

According to an example of the present disclosure, the outward pulling action can be opposite to the first gesture in the performing direction.

S207: the first terminal 10 detecting a continuous action from outward pulling to releasing.

According to an example of the present disclosure, the performing process of step S207 is the same as the performing process of step S204, and details are not repeatedly described herein.

S208: the first terminal 10 displaying in conjunction with a display content of the second terminal 20.

According to an example of the present disclosure, the first terminal 10 can display the display content of the second terminal 20 in the selected display region 100 described above, while the remaining portion still maintains the original display data. At this time, the second terminal 20 can maintain the original display content or jump to other interfaces, such as a texting reply interface.

In addition, after step S208 is executed, it is allowed to return to execute step S202.

As can be seen from the above description, when the interactive display method is performed, the user only needs to perform a corresponding operation using a finger while performing a gesture, and an arm of the user does not need to be kept in a hanging state all the time, thus improving comfort of the user.

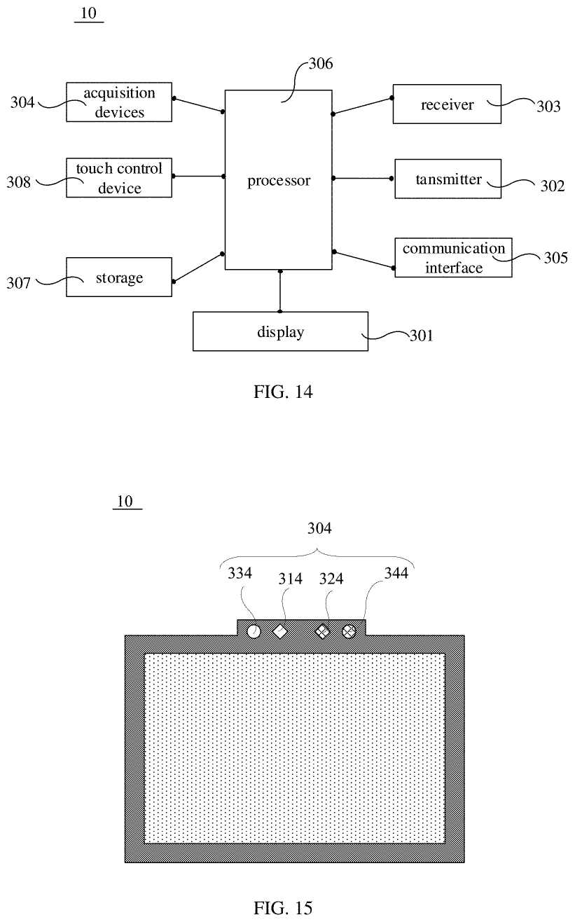

An embodiment of the present disclosure provides a terminal, namely the first terminal 10 or the second terminal 20 mentioned above. As shown in FIG. 14, taking the first terminal 10 as an example, the first terminal 10 comprises a display 301, a transmitter 302, a receiver 303, at least one set of acquisition devices 304, and a communication interface 305 connected by a bus. Among them, the communication interface 305 is configured to establish a connection between one terminal and another terminal. For example, the first terminal 10 can be connected to the second terminal 20 by the communication interface 305 described above.

The acquisition devices 304 are configured to obtain a gesture of a user, wherein the gesture comprises the first gesture, the second gesture and the third gesture described above.

In addition, the first terminal 10 further comprises a processor 306, which comprises a graphics processing unit (GPU), and a central processing unit (CPU) or a microcontroller unit (MCU). Among them, the GPU can not only process a 2D image, but also process a 3D image, which is not limited thereto in the embodiment of the present disclosure. The CPU can process and judge the gesture information obtained by the acquisition devices 304, and send a corresponding control instruction to the receiver 303 or the transmitter 302 according to the processing result. The transmitter 302 is configured to send a display data of the terminal to another terminal according to the control instruction of the processor.

For example, when the processor 306 determines the first gesture performed by the user, the transmitter 302 of the first terminal 10 can send a first display data of the first terminal 10 to the second terminal 20 according to the control instruction of the processor.

The receiver 303 is configured to receive a display data sent by the another terminal.

For example, the receiver 303 of the first terminal 10 can receive a second display data of the second terminal.

The display 301 is configured to display data.

It should be noted that the display 301 can be a liquid crystal display or an organic light-emitting diode display.

In the present disclosure, for example, the first terminal 10 further comprises a storage (RAM) 307 for the user to store information and a touch control device (TX/RX) 308.

It should be noted that, the above description takes the first terminal 10 as an example to describe the internal structure of the terminal. The structure of the second terminal 20 is the same as that described above, and details are not repeatedly described herein.

In addition, the aforementioned terminal (namely the first terminal 10 or the second terminal 20) has the same technical effects as the interactive display method provided by the aforementioned embodiment, and details are not repeatedly described herein.

For example, after the terminal establishes a connection with another terminal, before the terminal obtains a first gesture of the user, the acquisition devices further obtain a second gesture of the user; the processor determines a selected display region in a display image of the terminal defined by the user according to the second gesture; the transmitter sends a part of the first display data that matches the selected display region to the another terminal according to an instruction generated by the processor based on the first gesture and the second gesture.

For example, the acquisition devices obtain a third gesture of the user; the receiver receives at least a part of the display data sent by the another terminal according to an instruction generated by the processor based on the third gesture.

For example, the acquisition devices obtain the first gesture and the third gesture of the user; the processor determines the first gesture and the third gesture, and generates a control instruction; and the receiver receives at least a part of the display data sent by the another terminal according to the control instruction.

For example, after the acquisition devices obtain the third gesture of the user, the acquisition devices further obtain a time difference between an end of the first gesture and an beginning of the third gesture; the processor compares the time difference with a preset time, and when the time difference is less than or equal to the preset time, instructs the receiver to receive the at least a part of the display data sent by the another terminal.

For example, after a display of the another terminal displays, the another terminal further receives an operation instruction of the user; the another terminal generates a second display data and sends the second display data to the terminal according to the operation instruction; and at least a portion of the terminal displays the second display data.

For example, in a case that the acquisition devices of the terminal obtain the second gesture of the user and the processor determines the selected display region according to the second gesture, a portion of the display corresponding to the selected display region displays the second display data, and a remaining portion displays the first display data.

Hereinafter, taking that the first terminal 10 has a display screen of a large size and the second terminal 20 has a display screen of a small size as an example, the structure of the acquisition devices 304 are described in detail.

According to an example of the present disclosure, the acquisition device 304, as shown in FIG. 15, comprises a time of flight (TOF) camera 314 and a time of flight emitter 324.

The time of flight camera 314 and the time of flight emitter 324 undergo 3D imaging using the time of flight method. According to an example of the present disclosure, when the user performs the gesture described above, the time of flight emitter 324 emits light pulses to the user's finger continuously, the time of flight camera 314 receives the light beams returned from the finger, and obtains the movement track of the finger by detecting the time of flight of the light pulses, so as to achieve the purpose of acquiring the gesture.

Because the size of the display screen of the first terminal 10 is large, the distance between the user and the first terminal 10 is long. Therefore, the operation space for the user to perform the gesture is large. In this case, the brightness of the ambient light has a great effect on the accuracy of the data acquired by the acquisition devices 304.

The time of flight camera 314 and the time of flight emitter 324 have a better acquisition performance in dark light situations. Based on this, the time of flight camera 314 and the time of flight emitter 324 can be disposed on the first terminal 10 as shown in FIG. 15. And at the same time, in order to compensate for the acquisition performance in bright light situations, preferably, the acquisition devices 304 can further comprise a binocular camera, which consists of a left camera 334 and a right camera 344.

According to an example of the present disclosure, the binocular camera is based on the principle of parallax, and uses the left camera 334 and the right camera 344 to obtain two images of the finger being detected from different positions respectively, and obtains the three-dimensional geometric information of the finger by calculating the positional deviation between the corresponding points of the two images, and finally achieves the purpose of acquiring the gesture.

In the present disclosure, the azimuth terms “left” and “right,” etc., are defined with respect to the orientation in which the terminal is schematically placed in the accompanying drawings. It should be understood that these directional terms are relative concepts, and are used to describe and clarify relative position relationship, which may be changed accordingly depending on the orientation in which the terminal is placed.

Based on this, in the acquisition process, as shown in FIG. 16, the user is located in a far side interaction space S1 composed of the acquisition range of the binocular camera and the acquisition range of the time of flight camera 314 and the time of flight emitter 324.

It should be noted that, as can be seen from the above description, the distance between the first terminal 10 and the user is relatively long, so the user performs the gesture by a large limb operation. Therefore, the acquisition devices 304 of the first terminal 10 are not required to have a high acquisition accuracy for the gesture. Therefore, the requirement for the dual vision algorithm adopted by the binocular camera, and the requirement for the resolution of the photosensitive device in the time of flight camera 314 and the time of flight emitter 324, can be reduced, which is conducive to reducing the manufacturing cost of the product.

On the basis, for the second terminal 20 having a small size, the operations performed by the user comprise a contact operation (for example, a touch control operation) or a non-contact operation (for example, a gesture operation). When the user performs the gesture operation, because the distance between the user and the second terminal 20 is relatively short, the acquisition accuracy for the gesture is required to be high.

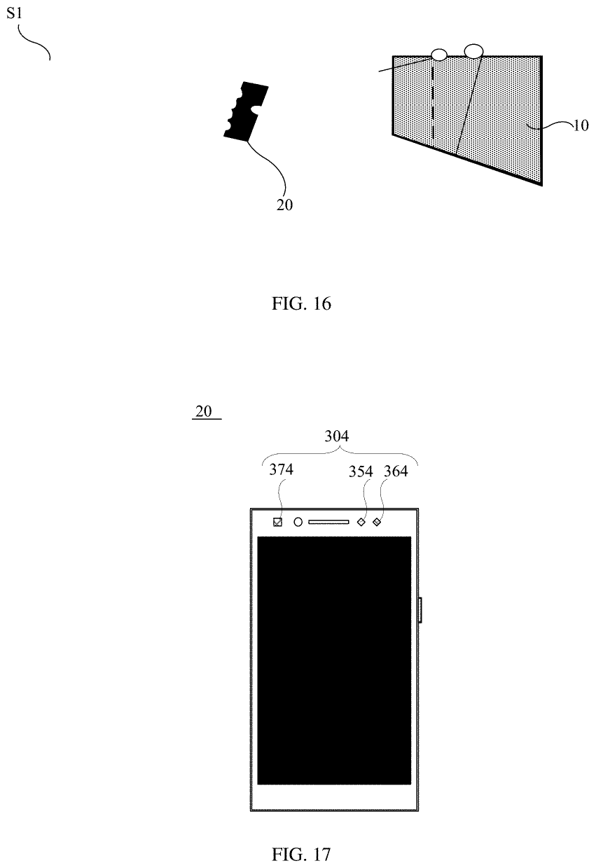

In this case, as shown in FIG. 17, the acquisition devices 304 comprise a structured light camera 354 and a structured light emitter 364.

According to an example of the present disclosure, the structured light emitter 364 projects an encoded graphic or the like formed by an encoded gratings or line light source onto the user's finger. In the process of the user performing the gesture, the finger may cause the aforementioned encoded graphic to be distorted. At this time, the structured light camera 354 decodes the distorted graphic to obtain the three-dimensional information of the finger, and finally achieves the purpose of acquiring the gesture.

On the basis, in order to further improve the detection accuracy of the gesture, the acquisition devices 304 mentioned above further comprise a radar microwave sensor 374. The radar microwave sensor 374 can emit a microwave through a transmitting antenna. In the process of the user performing the gesture, when the finger encounters the microwave, the microwave may be absorbed or reflected, so that the power of the microwave changes. In this case, a receiving antenna of the radar microwave sensor 374 can receive the reflected microwave and convert it into an electrical signal, so as to collect information such as the speed, distance, and angle of the finger movement, and finally achieve the purpose of acquiring the gesture.

It should be noted that, the time of flight camera 314 and the time of flight emitter 324 utilizing the time of flight principle can interfere with the structured light camera 354 and the structured light emitter 364 utilizing the structural principle. When the acquisition devices 304 in each terminal is provided with the time of flight camera 314 and the time of flight emitter 324, the structured light camera 354 and the structured light emitter 364 are not necessary to be provided, and vice versa.

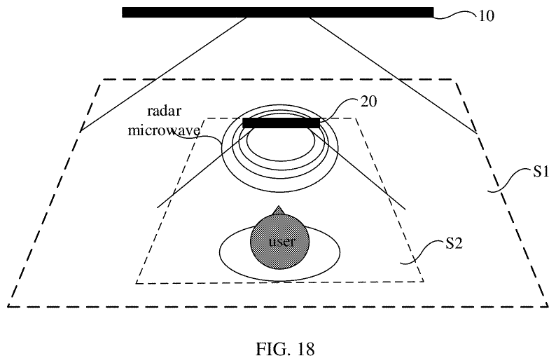

Based on this, in the process of the interactive display, as shown in FIG. 18, when the user is located in the far side interaction space S1 of the first terminal 10, the space other than the far side interaction space S1 is a blind space for the interactive display. In addition, the user is also located in a near side interaction space S2 of the second terminal 20.

The near side interaction space S2 is composed of the acquisition range of the structured light camera 354 and the structured light emitter 364, and the acquisition range of the radar microwave sensor 374, and the radar microwave sensor 374 can compensate for the acquisition range of the structured light camera 354 and the structured light emitter 364, so as to eliminate the blind space of the near side interaction space S2 and achieve a zero dead corner effect.

An embodiment of the present disclosure provides an interactive display system, which comprises at least two terminals described above. For example, the interactive display system comprises the first terminal 10 and the second terminal 20 that a connection has been established therebetween. In addition, for a multi-person interactive system, one first terminal 10 may establish a connection with at least two second terminals 20.

In addition, the interactive display system can further comprise a storage device, which is configured to store the first display data sent by the display terminals. The storage device can be a local storage device, and of course, can also be a cloud storage device.

The interactive display system mentioned above has the same technical effects as the terminal provided by the aforementioned embodiment, and details are not repeatedly described herein.

Those skilled in the art can understand: all or part of the steps to implement the embodiment of the aforementioned method can be accomplished by a related hardware instructed by a program; the program can be stored in a computer readable storage medium; when the program is executed, the steps comprised in the embodiment of the aforementioned method are executed; and the storage medium comprises: various media that can store program codes, such as a ROM, a RAM, a magnetic disk, or an optical disk, etc.

What have been described above are only specific implementations of the present disclosure, the protection scope of the present disclosure is not limited thereto. Any changes or substitutions easily occurring to those skilled in the art within the technical scope of the present disclosure should be covered in the protection scope of the present disclosure. Therefore, the protection scope of the present disclosure should be based on the protection scope of the claims.

The present application claims priority to Chinese patent application No. 201710880638.2, filed on Sep. 25, 2017, the entire disclosure of which is incorporated herein by reference as part of the present application.

1. An interactive display method, comprising:
establishing a connection between a first terminal and a second terminal;
obtaining a first gesture of a user;
the first terminal sending at least a part of first display data to the second terminal according to the first gesture; and
the second terminal displaying the at least a part of the first display data.

2. The interactive display method according to claim 1, wherein after establishing the connection between the first terminal and the second terminal, and before obtaining the first gesture of the user, the interactive display method further comprises:
obtaining a second gesture of the user;
the first terminal determining a selected display region in a display image of the first terminal defined by the user according to the second gesture.

3. The interactive display method according to claim 1, wherein the first terminal sending the at least a part of first display data to the second terminal according to the first gesture, comprises:
the first terminal sending a part of the first display data that matches the selected display region to the second terminal according to the first gesture.

4. The interactive display method according to claim 1, wherein after the first terminal sending the at least a part of first display data to the second terminal according to the first gesture, the interactive display method further comprises:
obtaining a third gesture of the user;
the second terminal displaying the at least a part of the first display data according to the third gesture.

5. The interactive display method according to claim 4, wherein after obtaining the third gesture of the user, the interactive display method further comprises:
obtaining a time difference between an end of the first gesture and an beginning of the third gesture;
comparing the time difference with a preset time, when the time difference is less than or equal to the preset time, the second terminal displaying the at least a part of the first display data.

6. The interactive display method according to claim 1, after the second terminal displaying, the interactive display method further comprises:
the second terminal receiving an operation instruction of the user;
the second terminal generating a second display data and sending the second display data to the first terminal according to the operation instruction; and
at least a portion of the first terminal displaying the second display data.

7. The interactive display method according to claim 6, wherein in a case of the second gesture of the user being obtained and the selected display region being determined according to the second gesture, the at least a portion of the first terminal displaying the second display data, comprises:
a portion of the first terminal corresponding to the selected display region displaying the second display data, and a remaining portion displaying the first display data.

8. The interactive display method according to claim 1, wherein establishing the connection between the first terminal and the second terminal, comprises:
establishing the connection between the first terminal and the second terminal in a peer to peer manner.

9. The interactive display method according to claim 1, wherein the first terminal sending the at least a part of first display data to the second terminal according to the first gesture, comprises:
the first terminal sending the at least a part of the first display data to a storage device;
the second terminal obtaining the at least a part of the first display data from the storage device and displaying.

10. A display terminal, comprising: a display, a transmitter, a receiver, at least one set of acquisition devices, a communication interface and a processor connected by a bus; wherein
the communication interface is configured to establish a connection between the terminal and another terminal;
the acquisition devices are configured to obtain a first gesture of a user;
the processor is configured to judge the first gesture and generate a control instruction;
the transmitter is configured to send a first display data of the terminal to the another terminal according to the control instruction;
the receiver is configured to receive a display data sent by the another terminal; and
the display is configured to display data.

11. The display terminal according to claim 10, wherein after establishing the connection with the another terminal, the acquisition devices further obtain a second gesture of the user;
the processor determines a selected display region in a display image of the terminal defined by the user according to the second gesture.

12. The display terminal according to claim 11, the transmitter sends a part of the first display data that matches the selected display region to the another terminal according to an instruction generated by the processor based on the first gesture and the second gesture.

13. The display terminal according to claim 10, wherein the acquisition devices obtain a third gesture of the user;
the receiver receives at least a part of the display data sent by the another terminal according to an instruction generated by the processor based on the third gesture.

14. The display terminal according to claim 13, wherein after the acquisition devices obtain the third gesture of the user, the acquisition devices further obtain a time difference between an end of the first gesture and an beginning of the third gesture;
the processor compares the time difference with a preset time, and when the time difference is less than or equal to the preset time, instructs the receiver to receive the at least a part of the display data sent by the another terminal.

15. The display terminal according to claim 10, wherein after a display of the another terminal displays, the another terminal further receives an operation instruction of the user;
the another terminal generates a second display data and sends the second display data to the terminal according to the operation instruction; and
at least a portion of the terminal displays the second display data.

16. The display terminal according to claim 15, wherein in a case that the acquisition devices of the terminal obtain the second gesture of the user and the processor determines the selected display region according to the second gesture,
a portion of the display corresponding to the selected display region displays the second display data, and a remaining portion displays the first display data.

17. An interactive display system, comprising at least two display terminals according to claim 10.

18. The display system according to claim 17, further comprising a storage device, wherein the storage device is configured to store the first display data sent by the display terminals.
